(19) United States
(12) Patent Application Publication
(10) Pub. No.: US 2016/0277572 A1
(43) Pub. Date: Sep. 22, 2016

(54) SYSTEMS, APPARATUSES, AND METHODS FOR VIDEO COMMUNICATION BETWEEN THE AUDIBLY-IMPAIRED AND AUDIBLY-CAPABLE

(71) Applicant: Sorenson Communications, Inc., Salt Lake City, UT (US)

(72) Inventors: Amy Benich, Draper, UT (US); Isaac Roach, Murray, UT (US); Mark Grossinger, Draper, UT (US); David Lance Pickett, Eagle Mountain, UT (US); Thomas Hawkes, Sandy, UT (US); Kevin Selman, Kaysville, UT (US)

(21) Appl. No.: 14/664,727

(22) Filed: Mar. 20, 2015

(51) Int. Cl. H04M 3/42; G09B 21/00; H04L 29/06; H04N 7/14; H04N 7/15

(52) U.S. Cl. CPC H04M 3/42391; H04N 7/147; H04N 7/152; H04L 65/1096; H04L 65/1046; G09B 21/009

(57) ABSTRACT

Systems, apparatuses, and methods for enabling electronic communication with an audibly-impaired user are disclosed. A system may include a relay service configured to provide translation services during a communication session between a first user and a second user. The relay service may be configured to receive near-end video data from a first communication device associated with the first user, transmit call assistant video data from a call assistant station associated with a call assistant to the first communication device, transmit and receive voice data to and from a second communication device associated with the second user, facilitate far-end video data to be transmitted from the second communication device to the first communication device, and facilitate the near-end video data to be transmitted from the first communication device to the second communication device.

### TECHNICAL FIELD

The application relates generally to video phone communication systems, and more specifically, to systems, apparatuses, and methods for providing video phone communication between an audibly-impaired person and an audibly-capable person through a relay service while at least substantially simultaneously providing a video connection between the audibly-impaired person and the audibly-capable person.

### BACKGROUND

Traditional communication systems, such as standard and cellular telephone systems, enable verbal communications between people at different locations. Communication systems for audibly-impaired individuals (e.g., individuals with hearing impairments, speech impairments, or a combination thereof) may also enable non-audible communications instead of, or in addition to, verbal communications. Some communication systems for audibly-impaired individuals enable communications between communication devices for audibly-incapable individuals (e.g., video phones, web cameras, etc.) and communication systems for audibly-capable individuals (e.g., standard telephones, cellular phones, etc.). For example, a video relay service (VRS) may provide speech to sign language translation services, and sign language to speech translation services for a communication session between a video communication device for an audibly-impaired individual and a traditional communication device for an audibly-capable user. In other words, the VRS may be used to facilitate a conversation between an audibly-impaired user and an audibly-capable person.

The audibly-impaired individual may communicate with a call assistant (e.g., communicate via sign language), and then the call assistant conveys the message audibly to a far-end user (e.g., an audibly-capable user). For communication in the other direction, the call assistant listens to the audibly-capable user and then signs what was spoken to the audibly-impaired user. The call assistant may, therefore, act as a translator for both the audibly-impaired user (e.g., using sign language) and the far-end user (e.g., communicating via speech communication). Thus, the call assistant directly communicates with each of the audibly-impaired individual and the audibly-capable individual to facilitate communication between the audibly-impaired individual and the audibly-capable individual. However, because the audibly-impaired individual and the audibly-capable individual do not directly communicate with each other, contextual cues (e.g., body language, tone of voice, etc.) may not be expressed or otherwise conveyed to the other party. Elements of communication, including emotions (e.g., happiness, sadness, excitement, frustration, etc.) and emotional connections between the audibly-impaired individual and the audibly-capable individual, may not be expressed or otherwise conveyed to the other party and the communication session may be less than desirable.

### SUMMARY

Embodiments described herein include methods and apparatuses that provide communication between a call assistant and each of an audibly-impaired user and an audible-capable user through a relay service while providing video communication between the audibly-impaired user and the audibly-capable user.

Embodiments of the disclosure include a system for enabling electronic communication with an audibly-impaired user. The system comprises a relay service configured to provide translation services during a communication session between a first user and a second user, the relay service configured to receive near-end video data from a first communication device associated with the first user, transmit call assistant video data from a call assistant station associated with a call assistant to the first communication device, transmit and receive voice data to and from a second communication device associated with the second user, facilitate far-end video data to be transmitted from the second communication device to the first communication device, and facilitate the near-end video data to be transmitted from the first communication device to the second communication device.

Also disclosed is an apparatus for an audibly-impaired user. The apparatus comprises a first communication device configured to facilitate a communication session between a first user at the first communication device and a second user at a second communication device through a relay service configured to provide translation services, the first communication device configured to receive and display far-end video data from the second communication device and receive and display call assistant video data from the relay service.

Also disclosed is a communication device configured for communication with a first communication device associated with an audibly-impaired individual. The apparatus comprises a second communication device associated with an audibly-capable individual, the second communication device configured to transmit and receive voice data to and from a relay service configured to provide translation services, transmit far-end video data to the first communication device, and receive near-end video data from the first communication device.

Also included are methods of establishing a communication session between an audibly-impaired user and an audibly-capable user. The method comprises facilitating transmission of near-end video data from a first communication device to a second communication device, facilitating transmission of far-end video data from the second communication device to the first communication device, facilitating transmission of call assistant video data from a call assistant station of a relay service to the first communication device, and facilitating transmission of voice data between the relay service and the second communication device.

Also disclosed is a system for establishing a communication session between an audibly-impaired user and an audibly-capable user. The system comprises a first communication device associated with the audibly-impaired user, the first communication device configured to transmit near-end video data to a relay service, receive far-end video data associated with the audibly-capable user from the relay service, and receive call assistant video data associated with a call assistant from the relay service. The system further comprises a second communication device associated with the audibly-capable user, the second communication device configured to receive the near-end video data and transmit and receive voice data to and from the relay service. The system further comprises the relay service, wherein the relay service comprises a call assistant station configured to transmit and receive the voice data to and from the second communication device and a routing server configured to receive the near-end video data, the far-end video data, and the call assistant video data.

### BRIEF DESCRIPTION OF THE SEVERAL VIEWS OF THE DRAWINGS

FIG. 1 is a simplified block diagram of a communication system configured to enable communication with an audibly-impaired individual according to embodiments of the disclosure;

FIG. 2 is a simplified schematic block diagram of processing hardware of a communication device for an audibly-impaired individual that may be used in accordance with one or more embodiments of the disclosure;

FIG. 3 is a simplified schematic block diagram of processing hardware of a communication device for an audibly-capable user that may be used in accordance with one or more embodiments of the disclosure;

FIG. 4 is a flowchart illustrating a method for establishing a communication session according to some embodiments of the disclosure; and

FIG. 5 shows example user interfaces used according to some embodiments of the disclosure.

### DETAILED DESCRIPTION

In the following detailed description, reference is made to the accompanying drawings which form a part hereof, and in which is illustrated specific embodiments in which the disclosure may be practiced. These embodiments are described in sufficient detail to enable those of ordinary skill in the art to practice the disclosure. It should be understood, however, that the detailed description and the specific examples, while indicating examples of embodiments of the disclosure, are given by way of illustration only and not by way of limitation. From this disclosure, various substitutions, modifications, additions rearrangements, or combinations thereof within the scope of the disclosure may be made and will become apparent to those of ordinary skill in the art.

In accordance with common practice, the various features illustrated in the drawings may not be drawn to scale. The illustrations presented herein are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method. In addition, like reference numerals may be used to denote like features throughout the specification and figures.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It should be understood by a person of ordinary skill in the art that the signal may represent a bus of signals, wherein the bus may have a variety of bit widths and the embodiments disclosed herein may be implemented on any number of data signals including a single data signal.

The various illustrative logical blocks, modules, circuits, and algorithm acts described in connection with embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein.

A processor herein may be any processor, controller, microcontroller, or state machine suitable for carrying out processes of the disclosure. A processor may also be implemented as a combination of computing devices, such as a combination of a DSP and a microprocessor, a plurality of microprocessors, one or more microprocessors in conjunction with a DSP core, or any other such configuration. When configured according to embodiments of the disclosure, a special-purpose computer improves the function of a general-purpose computer because, absent the disclosure, the general-purpose computer would not be able to carry out the processes of the disclosure. The disclosure also provides meaningful limitations in one or more particular technical environments that go beyond an abstract idea. For example, embodiments of the disclosure provide improvements in the technical field of telecommunications, relay services for the audibly-impaired, and in particular developing new communication devices that include new features and functionality for the user devices as well as the relay service devices.

In addition, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more computer-readable instructions (e.g., software code) on a computer-readable medium. Computer-readable media includes both computer storage media and communication media including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements.

As used herein, voice-capable networks and voice-capable equipment means networks and equipment that can process, convey, reproduce, or a combination thereof, sounds in the auditory frequencies as analog signals, digital signals, or a combination thereof. As non-limiting examples, such equipment includes conventional telephones, conventional cellular telephones, and conventional computers or handheld devices with microphone and speaker type capabilities. As non-limiting examples, such networks include a telephone network such as the Public Switched Telephone Network (PSTN) and other networks that are compatible and configured to provide communications using digital standards and data packets, an example of which includes Voice Over Internet Protocol (VOIP).

As used herein, video-capable networks and video-capable equipment means networks and equipment that can process, convey, reproduce, or a combination thereof, multi-frame images. As non-limiting examples, such equipment includes conventional cellular telephones with video capability, and conventional computers or handheld devices with camera and display type capabilities. As non-limiting examples, such networks include cellular networks, WiFi networks, wide area networks, hard wired networks and other private data networks configured to provide communications using digital standards and data packets. To facilitate the enhanced bandwidth needs of video phones, the video-capable networks may be implemented as a high bandwidth network such as a DSL, Cable, Ethernet, or other enhanced-bandwidth networking technology.

In general, most video-capable networks would be considered to also be voice-capable networks and most video-capable equipment would also be considered to be voice-capable equipment.

In a typical relay service for users having disabilities, a first communication device may be operated by an audibly-impaired user, and a second communication device may be operated by an audibly-capable user. Generally, when discussing calls, they are referred to from the perspective of the audibly-impaired user. Thus, an “incoming call” may originate from an audibly-capable user to an audibly-impaired user, and an “outgoing call” may originate from an audibly-impaired user to an audibly-capable user. Thus, for convenience, the communication device associated with the audibly-impaired user may also be referred to as a “near-end” device, while the communication device associated with the audibly-capable user may be referred to herein as a “far-end” device. Similarly, the user of the near-end device may be referred to as a “near-end” user, and the user of the far-end device may be referred to herein as a “far-end user.” Of course, it is recognized that “near-end” and “far-end” are relative terms depending on the perspective of the particular user. Thus, the terms “near-end” and “far-end” are used as a convenient way to distinguish between users and devices.

Embodiments discussed herein include systems, apparatuses, and methods for operating a communication system. The communication system provides video communication between an audibly-impaired user and a call assistant (e.g., via a video phone), voice communication between an audibly-capable user and the call assistant (e.g., via a telephone, cellular phone, etc.), and video communication between the audibly-impaired user and the audibly-capable user (e.g., via a video phone).

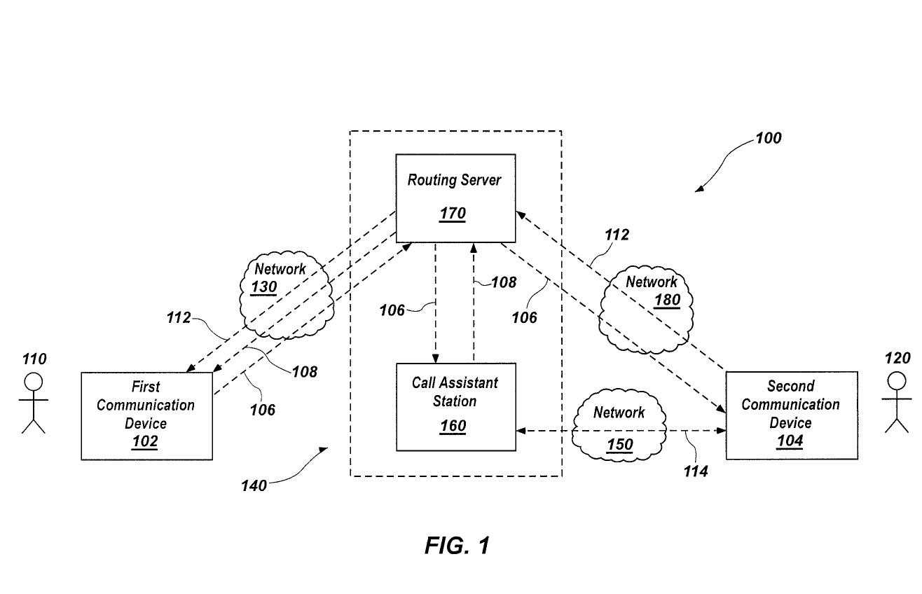

FIG. 1 is a simplified block diagram of a communication system 100 configured to facilitate communications between the audibly-impaired and the audibly-capable. The communication system 100 enables an audibly-impaired user 110 to engage in conversation through the communication system 100 with an audibly-capable user 120. The audibly-impaired user 110 may have a condition that may make it difficult to communicate with the audibly-capable user 120. The audibly-impaired user 110 may exhibit varying levels of impairment and may be a voice-capable audibly-impaired user or a voice-incapable audibly-impaired user. The audibly-impaired user 110 may be a hearing-impaired (e.g., deaf, hard-of-hearing, etc.) user, a speech-impaired (e.g., mute) user, or have some other impairment or combination thereof.

A communication session between the audibly-impaired user 110 and the audibly-capable user 120 may be facilitated through the use of various types of equipment, which may be coupled together using one or more networks (e.g., video-capable networks 130, 180, and voice-capable network 150). For ease of description, the networks 130, 150, 180 are shown as separate networks to describe the different types of data transmitted between different equipment; however, it should be understood that the networks 130, 150, 180 may be the same networks or different networks. The networks 130, 150, 180 may include internet protocol (IP) networks. The networks 130, 150, 180 may also include other networks, such as, for example, public switched telephone networks (PSTNs). The networks 130, 150, 180 may include a wide area network (WAN), a local area network (LAN), a personal area network (PAN), and combinations thereof. The networks 130, 150, 180 may include a cloud network. The networks 130, 150, 180 may be configured to facilitate wireless communications, communications through cables, and combinations thereof. Some non-limiting examples of wireless communications (e.g., wireless electromagnetic signals) may include “WiFi,” Bluetooth, Zigbee, near-field communication, and mobile wireless networks (e.g., cellular networks). Some non-limiting examples of suitable cables include fiber-optic cables, coaxial cables, traditional telephone cables, and Ethernet cables. As will be described herein, the networks 130, 150, 180 may be configured to transmit video data (e.g., signals) 106, 108, 112 and also to transmit voice data 114 (e.g., audio data).

To assist the audibly-impaired user 110 to communicate with users of voice-based communication system, interpretive services may be employed allowing audibly-impaired users to communicate with a translator, such as, for example, through sign language. The communication system 100 may include a relay service 140 (e.g., a video relay service (VRS)) configured to communicate with the audibly-impaired user 110 through a first communication device 102 (e.g., a video endpoint, such as a video phone, a computer, a tablet, etc.) and configured to communicate with the audibly-capable user 120 through a second communication device 104 (e.g., a communication endpoint, such as a conventional voice phone, a video phone, a computer, a tablet, etc.). Thus, the relay service 140 may be configured to interpret communication between the first communication device 102 and the second communication device 104. An operator (e.g., translator) at the relay service 140 may perform the interpretation services. The operator may also be referred to as a “call assistant.”

The relay service 140 may include a call assistant station 160 and a routing server 170. The routing server 170 may be configured to receive and redirect various video data 106, 108, 112 received from the first communication device 102, the call assistant station 160, and the second communication device 104, to and from various equipment. The routing server 170 may include a multipoint control unit (MCU) configured to bridge multiple connections. Communication between the first communication device 102 and the relay service 140 may be performed through video and/or text communication between the audibly-impaired user 110 and the call assistant, while communication between the relay service 140 and the second communication device 104 may be performed using voice communication between the call assistant and the audibly-capable user 120.

The first communication device 102 may include a communication device for an audibly-impaired user. Communication devices that may be used to assist users having such conditions may include a video phone device, a web camera configured for videoconferencing, a text-captioned device, keyboards, other devices or accessibility interfaces, and combinations thereof. The first communication device 102 may include a computing device configured to execute software directed to perform such communication capabilities. Examples of suitable computing devices may include a desktop computer, a laptop computer, a tablet computer, a personal digital assistant (PDA), a smartphone, and other computing devices. The first communication device 102 may include video-capable equipment suitable for transmitting and receiving video signals.

As discussed above, communication between the audibly-impaired user 110 and the audibly-capable user 120 is established through a call assistant at the relay service 140. The audibly-impaired user 110 may communicate directly with the call assistant using physical expressions (e.g., sign language, facial expressions, lip reading, and/or other body language) over a video-capable network 130. The call assistant translates the communication from the audibly-impaired user 110 and communicates with the audibly-capable user 120 with verbal expressions over a voice-capable network 150. In turn, the audibly-capable user 120 verbally communicates with the call assistant, who then translates the verbal communications using physical expressions (e.g., sign language, facial expressions, lip reading, and/or other body language) for the audibly-impaired user 110 over the video-capable network 130.

The physical expressions of the audibly-impaired user 110 may be captured by the first communication device 102 in the form of near-end video data 106 (e.g., video signals). The near-end video data 106 associated with the audibly-impaired user 110 may be transmitted from the first communication device 102 to the relay service 140 (e.g., via the routing server 170) to facilitate visual communication between the audibly-impaired user 110 and the call assistant. Similarly, the physical expressions of the call assistant may be captured by the call assistant station 160 in the form of call assistant video data 108. The call assistant video data 108 may be transmitted from the call assistant station 160 to the first communication device 102 (e.g., via routing server 170) to facilitate communication between the call assistant and the audibly-impaired user 110. Thus, the first communication device 102 may be configured to transmit (i.e., send) the near-end video data 106, and may also be configured to receive the call assistant video data 108 from the relay service 140. Similarly, the relay service 140 may be configured to communicate (i.e., transmit and/or receive) the video data 106, 108 with the first communication device 102. As a result, the audibly-impaired user 110 and the call assistant may communicate with each other using physical expressions.

The second communication device 104 may include a communication device for the audibly-capable user 120. Suitable communication devices may include a telephone, a cellular phone, a smartphone, a video phone, a desktop computer, a laptop computer, a tablet computer, a personal digital assistant (PDA), and other communication devices. The second communication device 104 may include voice-capable equipment and may also include video-capable equipment.

Communication between the audibly-capable user 120 and the call assistant may be established through the voice-capable network 150. The voice data 114 may be communicated between the second communication device 104 and the call assistant station 160 via the voice-capable network 150 to facilitate voice communication between the audibly-capable user 120 and the call assistant at the relay service 140. The voice data 114 may include audible information conveying audio signals of the audibly-capable user 120 and the call assistant. For example, the voice data 114 may include audible speech of the call assistant and the audibly-capable user 120. Thus, the second communication device 104 may be configured to transmit and receive the voice data 114 to and from the relay service 140. Similarly, the relay service 140 may be configured to transmit and receive the voice data 114 to and from the second communication device 104. As a result, the audibly-capable user 120 and the call assistant may communicate with each other through a voice-based dialogue conveyed over the voice-capable network 150.

During normal communications between the audibly-impaired user 110 and the audibly-capable user 120, a call may be placed to or from the audibly-impaired user 110. When the call is received, the audibly-impaired user 110 may communicate indirectly with the audibly-capable user 120 through the call assistant at the relay service 140. By way of example, the audibly-impaired user 110 may communicate with the call assistant using physical expressions. The call assistant may translate the communication from the audibly-impaired user 110 and communicate with the audibly-capable user 120 with a voice-based dialogue. In the other direction, the audibly-capable user 120 may communicate a voice-based message to the call assistant. The call assistant may translate the message from the audibly-capable user 120 for the audibly-impaired user 110 using physical expressions, which may be displayed to the audibly-impaired user 110 on the first communication device 102.

During a communication session, nuances such as body language, tone of voice, emotion (e.g., happiness, sadness, excitement, frustration, exasperation, etc.), contextual meaning, etc., may not be understood or otherwise communicated by the call assistant to either the audibly-impaired user 110 or the audibly-capable user 120. By way of example, the audibly-impaired user 110 may express visible frustration, anxiety, sarcasm, impatience, happiness, or other emotions that may not be noticed or effectively communicated to the audibly-capable user 120. Similarly, the audibly-capable user 120 may express verbal frustration, sarcasm, or other emotions conveyed through expressions and tone of voice that may not be effectively communicated to the audibly-impaired user 110. Because the audibly-impaired user 110 and the audibly-capable user 120 do not communicate directly with each other, such emotions, body language, and contextual cues may not be communicated to or from either party. Thus, it may be desirable to provide at least some form of direct communication between the audibly-impaired user 110 and the audibly-capable user 120.

Accordingly, with continued reference to FIG. 1, the communication system 100 may further facilitate video communication between the first communication device 102 and the second communication device 104. Thus, the audibly-impaired user 110 and the audibly-capable user 120 may communicate their physical expressions directly with each other, which may supplement the translation services provided by the call assistant.

The first communication device 102 and the second communication device 104 may be configured to transmit and receive video data with each other via the video-capable networks 130, 180 to facilitate visual communication between the audibly-impaired user 110 and the audibly-capable user 120. For example, the first communication device 102 may be configured to transmit near-end video data 106 to the relay service 140. The relay service 140 may be configured to route the near-end video data 106 to the second communication device 104, which may be configured to receive and display the near-end video data 106. The second communication device 104 may be configured to transmit far-end video data 112 to the relay service 140. The relay service 140 may be configured to route the far-end video data 112 to the first communication device 102, which may be configured to receive and display the far-end video data 112.

Thus, the first communication device 102 may be configured to transmit near-end video data 106 to the relay service 140, and may also be configured to simultaneously receive video data (e.g., call assistant video data 108, far-end video data 112) from the relay service 140. As a result, the first communication device 102 may be configured to simultaneously display images of the call assistant and images of the audibly-capable user 120 so that the audibly-impaired user 110 can see the audibly-capable user 120 and the call assistant during the communication session. This is in contrast with conventional communication sessions in which the audibly-impaired user 110 only sees the call assistant. Thus, the audibly-impaired user 110 may have an improved understanding of the conversation by viewing contextual cues from the expressions of the audibly-capable user 120 in addition to the sign language provided by the call assistant.

The second communication device 104 may be configured to transmit far-end video data 112 to the relay service 140, and simultaneously receive the near-end video data 106 from the relay service 140. Receipt of the near-end video data 106 may enable the audibly-capable user 120 to observe physical expressions of the audibly-impaired user 110. At the same time, the second communication device 104 may be configured to transmit and receive the voice data 114 via the voice-capable network 150 to and from the relay service 140. Accordingly, the second communication device 104 may be configured to allow the audibly-capable user 120 to verbally communicate with the call assistant at the relay service 140 while simultaneously visually communicating with the audibly-impaired user 110 at the first communication device 102. The second communication device 104 may be configured to display video images of the audibly-impaired user 110 while receiving the voice data 114 from the relay service 140. This is in contrast with conventional communication sessions in which the audibly-capable user 110 only communicates verbally the call assistant without supplemental video data. Thus, the audibly-capable user 120 may have an improved understanding of the conversation by viewing contextual cues from the expressions of the audibly-impaired user 110 in addition to the voice provided by the call assistant. As both users 110, 120 may have an improved understanding, the entire conversation may be more enjoyable, effective, and unique for both parties. The second communication device 104 may not transmit or receive video data to or from the relay service 140.

In some embodiments, the second communication device 104 may include a single device capable of transmitting and receiving the video data 106, 112 in addition to transmitting and receiving voice data 114. In such an embodiment, the single device may be configured to execute different applications that perform the different functions, or a single application that is capable of performing the different functions. In some embodiments, the second communication device 104 may employ multiple devices configured to perform these functions. For example, the second communication device 104 may include a first device capable of transmitting and receiving video data 106, 112 (e.g., laptop computer, desktop computer, television, tablet computer, camera, etc.), and a second device capable of transmitting and receiving voice data 114 (e.g., a standard telephone, a cellular phone, etc.). By way of example, in some embodiments both the first communication device 102 and the second communication device 104 may be video phones of a video relay service communication system.

Although the relay service 140 has been described as a video relay service, the relay service 140 may also be configured as a voice carry over (VCO) service wherein the audibly-impaired user 110 speaks directly to the audibly-capable user 120 over a voice-capable network and the audibly-capable user 120 speaks to a call assistant who then translates and types the communication of the audibly-capable user 120 to be visually (e.g., textually) displayed to the audibly-impaired user 110.

Although the video data 106, 112 has been described herein as being transmitted between the first communication device 102 and the second communication device 104 via the relay service 140, in some embodiments the video data 106, 112 may be transmitted directly between the first communication device 102 and the second communication device 104, through a network without the relay service 140. For example, the first communication device 102 may be configured to transmit the near-end video data 106 directly to the second communication device 104 and may also be configured to receive the far-end video data 112 directly from the second communication device 104. Similarly, the second communication device 104 may be configured to transmit the far-end video data 112 directly to the first communication device 102 and may also be configured to receive the near-end video data 106 directly from the first communication device 102. Thus, the first communication device 102 may be configured to transmit the near-end video data 106 to relay service 140 and to the second communication device 104 at the same time.

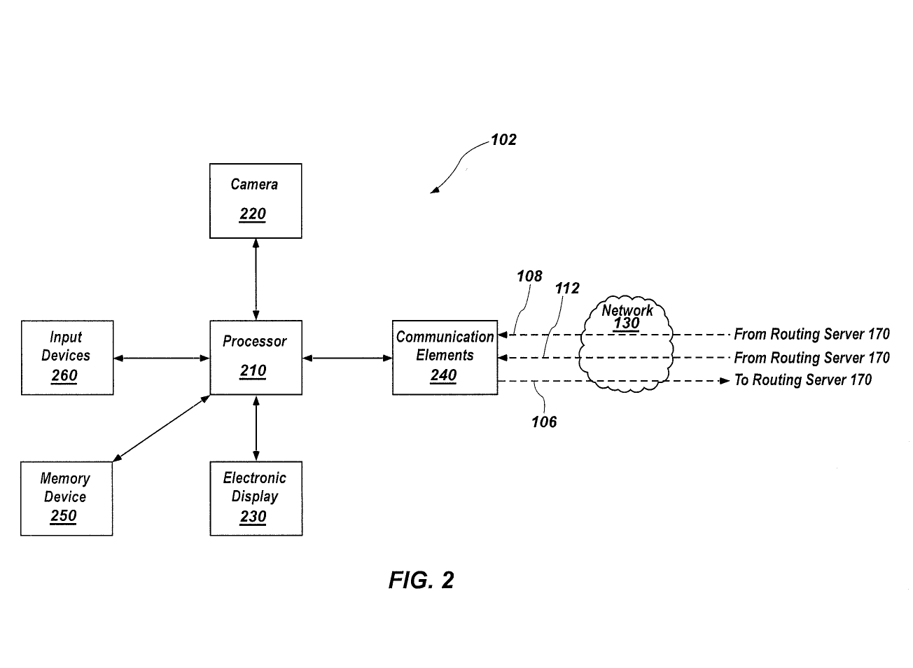

FIG. 2 is a simplified schematic block diagram of the first communication device 102 of FIG. 1. The first communication device 102 may include a processor 210 operably coupled with a camera 220, an electronic display 230, communication elements 240, a memory device 250, and input devices 260.

The processor 210 may coordinate the communication between the various devices as well as execute instructions stored in computer-readable media of the memory device 250. The processor 210 may be configured to execute a wide variety of operating systems and applications including the computing instructions. The memory device 250 may be used to hold computing instructions, data, and other information for performing a wide variety of tasks including performing embodiments disclosed herein. By way of example and not limitation, the memory device 250 may include Synchronous Random Access Memory (SRAM), Dynamic RAM (DRAM), Read-Only Memory (ROM), Flash memory, and the like. The memory device 250 may include volatile and non-volatile memory storage for the first communication device 102.

The communication elements 240 may be configured for communicating with other devices or communication networks. As non-limiting examples, the communication elements 240 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1 a/b/g/n type wireless connections, and other suitable communication interfaces and protocols.

The input devices 260 may include a numeric keypad, a keyboard, a touchscreen, a remote control, a mouse, other input devices, or combinations thereof. For example, during a communication session, the audibly-impaired user 110 may desire to enter data to transmit to the relay service 140, the second communication device 104, and combinations thereof. By way of example, a user may initiate a communication session in a conventional manner by entering a phone number of a person with whom the user wishes to communicate.

As discussed above, the first communication device 102 may be configured to capture near-end video data 106 from the camera 220 and transmit the near-end video data 106 to the relay service 140 through the communication elements 240. The near-end video data 106 captured by the camera 220 may include sign language communication originated by the audibly-impaired user 110. The near-end video data 106 may be transmitted to the call assistant station 160 as well as the second communication device 104 via the routing server 170 of the relay service 140. In some embodiments, the near-end video data 106 may be transmitted to the call assistant station 160 via the routing server 170 of the relay service 140, and transmitted to the second communication device 104 via a different network outside of the relay service 140.

The communication elements 240 may also be configured to receive call assistant video data 108 from the relay service 140 to be displayed by the electronic display 230. The communication elements 240 may also be configured to receive far-end video data 112 associated with the audibly-capable user 120 to be displayed by the electronic display 230. The far-end video data 112 may be received via the relay service 140. In some embodiments, the far-end video data 112 may be received from a different network outside of the relay service 140.

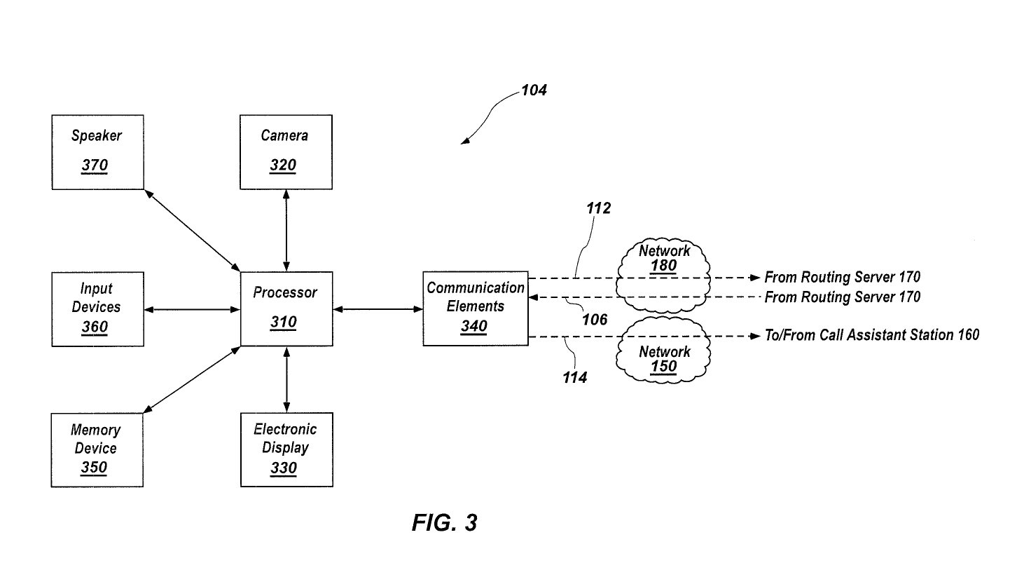

FIG. 3 illustrates a simplified schematic block diagram of the second communication device 104 of FIG. 1. The second communication device 104 may include a processor 310 operably coupled with a camera 320, an electronic display 330, communication elements 340, a memory device 350, input devices 360, and a speaker 370.

The processor 310 may coordinate the communication between the various devices as well as execute instructions stored in computer-readable media of the memory device 350. The processor 310 may be configured to execute a wide variety of operating systems and applications including the computing instructions. The memory device 350 may be used to hold computing instructions, data, and other information for performing a wide variety of tasks including performing embodiments disclosed herein. By way of example and not limitation, the memory device 350 may include Synchronous Random Access Memory (SRAM), Dynamic RAM (DRAM), Read-Only Memory (ROM), Flash memory, and the like. The memory device 350 may include volatile and non-volatile memory storage for the second communication device 104.

The communication elements 340 may be configured for communicating with other devices or communication networks. As non-limiting examples, the communication elements 340 may include elements for communicating on wired and wireless communication media, such as for example, serial ports, parallel ports, Ethernet connections, universal serial bus (USB) connections IEEE 1394 (“firewire”) connections, Bluetooth wireless connections, 802.1 a/b/g/n type wireless connections, and other suitable communication interfaces and protocols.

The input devices 360 may include a numeric keypad, a keyboard, a touchscreen, a remote control, a mouse, other input devices, or combinations thereof. For example, during a communication session, the audibly-capable user 120 may desire to communicate with the calling assistant using a microphone to convey voice communications.

As discussed above, the second communication device 104 may be configured to communicate voice data 114 captured by the input devices 360 (e.g., a microphone), and transmit the voice data 114 to the relay service 140. The second communication device 104 may also be configured to receive voice data 114 through the communication elements 340 from the relay service 140 to be output by the speaker 370 (e.g., speakerphone, handset, etc.).

The second communication device 104 may also be configured to capture far-end video data 112 by the camera 320, and transmit the far-end video data 112 to the first communication device 102 through the communication elements 340. The far-end video data 112 captured by the camera 320 may include physical expressions originated by the audibly-capable user 120. The communication elements 340 may be configured to receive the near-end video data 106 from the first communication device 102 to be displayed by the electronic display 330. The near-end video data 106 received by the second communication device 104 may include physical expressions originated by the audibly-impaired user 110 at the first communication device 102.

Accordingly, the second communication device 104 may be configured to simultaneously communicate with the relay service 140 (e.g., voice data 114) and with the first communication device 102 (e.g., video data 106, 112). As a result, the audibly-capable user 120 may communicate with the audibly-impaired user 110 through physical expressions while at the same time receiving translated verbal communication from the call assistant at the relay service 140. Although FIG. 3 depicts the voice-capable network 150 and the video-capable network 180 as separate networks, the networks may be the same (e.g., the internet) and the voice data 114 and the video data 106, 112 may be transmitted over the same network.

The second communication device 104 may be configured to execute software configured to provide video communication between the second communication device 104 and the first communication device 102 via the video-capable network 180 while also providing voice communication between the second communication device 104 and the relay service 140. In some embodiments, the software may include one or more applications stored on the second communication device 104. In some embodiments, the software may be accessed remotely (e.g., as a website) to facilitate the video communication. The software may be downloaded to the second communication device 104 and may be stored in the memory device 350. The software may facilitate transmitting the far-end video data 112 to the routing server 170, receiving the near-end video data 106 from the routing server 170, transmitting the voice data 114 to the call assistant station 160, and receiving the voice data 114 from the call assistant station 160. The software may be executed via processing circuitry of the processor 310. The application may be Skype, Facetime®, or other video communication application.

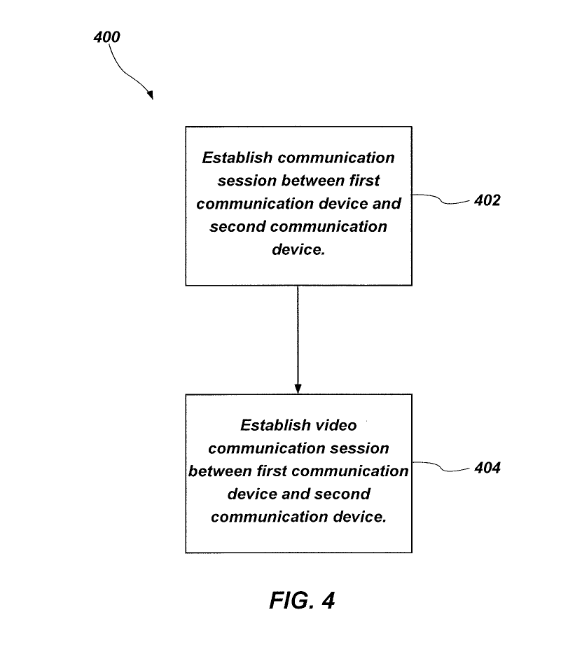

FIG. 4 is a flowchart 400 illustrating a method of establishing a communication session according to embodiments of the disclosure. Reference may also be made to FIGS. 1 through FIG. 3 when describing the flowchart 400.

At operation 402, a communication session may be established between the first communication device 102 and the second communication device 104. For example, one of the audibly-impaired user 110 and the audibly-capable user 120 may place a call, which may be routed to the relay service 140 to establish the three-way communication session involving the call assistant to provide translation services. As a result, a video communication session may be established between the audibly-impaired user 110 and the call assistant, and an audio communication session may be established between the call assistant and the audibly-capable user 120.

At operation 404, a video communication session may be established between the first communication device 102 and the second communication device 104. As a result, a video communication session may be established between the audibly-impaired user 110 and the audibly-capable user 120. The video communication session may continue until termination of the overall communication session with the relay service. In some embodiments, the users 110, 120 may independently terminate the video communication session without terminating the overall communication session. In some embodiments, the users 110, 120 may independently terminate the video communication session such that the video communication session may persist even after terminating the overall communication session.

In some embodiments, the audibly-impaired user 110 may initiate the video communication session with the audibly-capable user 120 using the input devices 260 of the first communication device 102. As a result, a video communication session request may be transmitted to the second communication device 104 to be approved by the audibly-capable user 120. The audibly-capable user 120 may accept the video communication session request at the second communication device 104 (e.g., by authorizing the request). In some embodiments, the audibly-capable user 120 may initiate the video communication session with the audibly-impaired user 110 using the input devices 360 of the second communication device 104. As a result, a video communication session request may be transmitted to the first communication device 102 to be approved by the audibly-impaired user 110. The audibly-impaired user 110 may accept the video communication session request at the first communication device 102. In some embodiments, the call assistant may be unaware that the video communication session has been established between the other parties to the overall communication session.

In some embodiments, the video communication session between the first communication device 102 and the second communication device 104 may be password enabled. One of the audibly-impaired user 110 and the audibly-capable user 120 may send a request to establish a video communication session to the other of the audibly-impaired user 110 and the audibly-capable user 120. The other of the audibly-impaired user 110 and the audibly-capable user 120 may receive the request. A password may be sent with the request to establish the video communication session. In some embodiments, the password is sent via a short message service (SMS) (e.g., text message) link sent to the audibly-capable user 120, email, instant message, verbally, and/or other suitable method to the audibly-capable user 120. In some embodiments, the password is communicated via the call assistant. The user 110, 120 receiving the password may enter the password into the respective input devices 260, 360 and the video communication session may be established after the password is entered into the respective input devices 260, 360.

In some embodiments, the video session between the first communication device 102 and the second communication device 104 may be automatically established. At operation 402 when the communication session between the first communication device 102 and the second communication device 104 is established, a video communication session request may automatically be sent by one of the first communication device 102 and the second communication device 104 to the other of the first communication device 102 and the second communication device 104. The audibly-impaired user 110 or the audibly-capable user 120 may have an account configured to recognize phone numbers or devices with which it would be desirable to establish a video communication session or with which a video communication session has previously been established. In such a case, when the communication session is established, the video communication session request may be automatically sent.

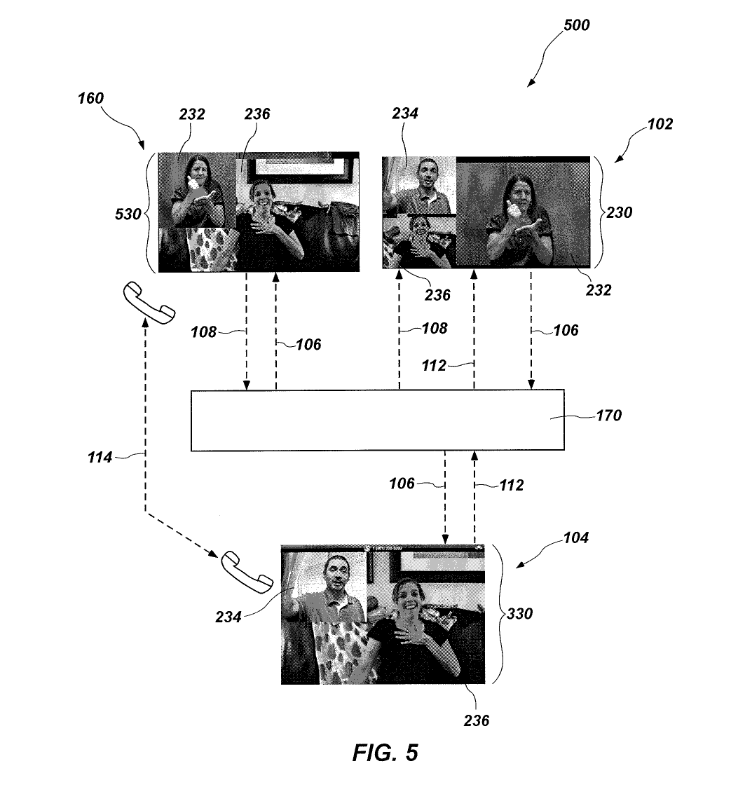

FIG. 5 is a schematic representation of a communication system 500 including user interfaces for each communication device used therein according to an embodiment of the disclosure. The communication system 500 includes the first communication device 102 with the electronic display 230, the second communication device 104 with the electronic display 330, and the call assistant station 160 with an electronic display 530.

The first communication device 102 may be configured to transmit the near-end video data 106 to the routing server 170, and to receive video data (the call assistant video data 108, the far-end video data 112) from the routing server 170. The electronic display 230 is configured to display a call assistant image 232 of the call assistant, a far-end user image 234 of the audibly-capable user 120, and a near-end user image 236 of the audibly-impaired user 110. Thus, the electronic display 230 may be configured to simultaneously display video images of the audibly-capable user 120 and video images of the call assistant during a communication session. Although the call assistant image 232 is depicted as being relatively larger than the near-end user image 234 and the far-end user image 236, the relative size and location of each image 232, 234, 236 is not so limited and may be different than illustrated. For example, the far-end user image 234 may be larger than the call assistant image 232. In some embodiments, the first communication device 102 may be configured to enable the audibly-impaired user 110 to select the placement and/or relative sizing of the different video feeds on the electronic display 230.

The second communication device 104 may be configured to transmit the far-end video data 112 to the routing server 170, and to receive the near-end video data 106 from the routing server 170. The second communication device 104 may also be configured to transmit and receive voice data 114 to and from the call assistant station 160. The electronic display 330 may be configured to display the near-end user image 236 and the far-end user image 234. Thus, the electronic display 230 may be configured to display video images of the audibly-impaired user 110 while receiving voice data 114 from the call assistant station 160. In some embodiments, the second communication device 104 may be configured to enable the audibly-capable user 120 to select the placement and/or relative sizing of the different video feeds on the electronic display 330.

The call assistant station 160 may be configured to transmit call assistant video data 108 to the routing server 170, and to receive the near-end video data 106 from the routing server 170. The call assistant station 160 may also be configured to transmit and receive voice data 114 from the second communication device 104. The electronic display 530 may be configured to display the near-end user image 236 and the call assistant image 232. In some embodiments, the call assistant station 160 may be configured to enable the call assistant to select the placement and/or relative sizing of the different video feeds on the electronic display 530.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of embodiments encompassed by the disclosure as contemplated by the inventors.

What is claimed is:

1. A system comprising:
a relay service configured to provide translation services during a communication session between a first user and a second user, the relay service configured to:
receive near-end video data from a first communication device associated with the first user;
transmit call assistant video data from a call assistant station associated with a call assistant to the first communication device;
transmit and receive voice data to and from a second communication device associated with the second user;
facilitate far-end video data to be transmitted from the second communication device to the first communication device; and
facilitate the near-end video data to be transmitted from the first communication device to the second communication device.

2. The system of claim 1, wherein the relay service further comprises a routing server configured to:
transmit the near-end video data to the second communication device; and
transmit the far-end video data to the first communication device.

3. The system of claim 2, wherein the routing server comprises a multipoint control unit.

4. The system of claim 1, wherein the call assistant station is configured to receive the near-end video data and the voice data.

5. The system of claim 4, wherein the call assistant station is configured to display the near-end video data and the call assistant video data on an electronic display for viewing by the call assistant.

6. An apparatus comprising:
a first communication device configured to facilitate a communication session between a first user at the first communication device and a second user at a second communication device through a relay service configured to provide translation services, the first communication device configured to:
receive and display far-end video data from the second communication device; and
receive and display call assistant video data from the relay service.

7. The apparatus of claim 6, wherein the first communication device is further configured to transmit near-end video data to both the relay service and to the second communication device.

8. The apparatus of claim 7, wherein the first communication device is configured to display the near-end video data at least substantially simultaneously with the far-end video data and the call assistant video data on an electronic display thereof.

9. The apparatus of claim 6, wherein the first communication device is configured to display the call assistant video data and the far-end video data simultaneously.

10. An apparatus configured for communication with a first communication device associated with an audibly-impaired individual, the apparatus comprising:
a second communication device associated with an audibly-capable individual, the second communication device configured to:
transmit and receive voice data to and from a relay service configured to provide translation services;
transmit far-end video data to the first communication device; and
receive near-end video data from the first communication device.

11. The apparatus of claim 10, wherein the second communication device is configured to receive the near-end video data while receiving the voice data.

12. The apparatus of claim 10, wherein the second communication device is configured to receive the near-end video from the first communication device through the relay service.

13. The apparatus of claim 10, wherein the second communication device is configured to transmit the far-end video data to the first communication device through a routing server of the relay service.

14. The apparatus of claim 10, further comprising an electronic display configured to display a multi-frame image of the audibly-impaired individual.

15. The apparatus of claim 14, wherein the electronic display is configured to display the multi-frame image of the audibly-impaired individual while receiving the voice data from the relay service.

16. The apparatus of claim 10, wherein the second communication device comprises a memory device configured to store a software application configured to facilitate transmitting the far-end video data to the first communication device and receiving the near-end video data from the first communication device.

17. The apparatus of claim 10, wherein the second communication device includes:
a first device configured to transmit and receive the voice data to and from the relay service; and
a second device configured to transmit the far-end video data, receive the near-end video data, and
display the near-end video data and the far-end video data.

18. A method of establishing a communication session between an audibly-impaired user and an audibly-capable user, the method comprising:
facilitating transmission of near-end video data from a first communication device to a second communication device;
facilitating transmission of far-end video data from the second communication device to the first communication device;
facilitating transmission of call assistant video data from a call assistant station of a relay service to the first communication device; and
facilitating transmission of voice data between the relay service and the second communication device.

19. The method of claim 18, wherein facilitating transmission of near-end video data from the first communication device to the second communication device includes routing the near-end video data to the second communication device through the relay service.

20. The method of claim 18, wherein facilitating transmission of the voice data between the relay service and the second communication device and facilitating transmission of the near-end video data from the first communication device to the second communication device occurs at least substantially simultaneously.

21. The method of claim 18, wherein facilitating transmission of far-end video data from the second communication device to the first communication device includes routing the far-end video data to the first communication device through the relay service.

22. The method of claim 18, further comprising facilitating transmission of the near-end video data from the first communication device to the call assistant station.

23. The method of claim 22, further comprising displaying the near-end video data and the call assistant video data on an electronic display of the call assistant station.

24. A system for establishing a communication session between an audibly-impaired user and an audibly-capable user, the system comprising:
a first communication device associated with the audibly-impaired user, the first communication device configured to:
transmit near-end video data to a relay service;
receive far-end video data associated with the audibly-capable user from the relay service; and
receive call assistant video data associated with a call assistant from the relay service;
a second communication device associated with the audibly-capable user, the second communication device configured to:
receive the near-end video data; and
transmit and receive voice data to and from the relay service; and
the relay service, wherein the relay service comprises:
a call assistant station configured to transmit and receive the voice data to and from the second communication device; and
a routing server configured to receive the near-end video data, the far-end video data, and the call assistant video data.

25. The system of claim 24, wherein the first communication device is configured to display the far-end video data and the call assistant video data.

26. The system of claim 24, wherein the second communication device is configured to display the near-end video data.

27. The system of claim 24, wherein the second communication device is configured to display the near-end video data while receiving the voice data.

28. The system of claim 24, wherein the first communication device is configured to display the far-end video data and the second communication device is configured to display the near-end video data.
